(19) United States
(12) Patent Application Publication
(10) Pub. No.: US 2025/0354795 A1
(43) Pub. Date: Nov. 20, 2025

(54) Tripod Head Position Identification Method and Electronic Device

(71) Applicant: Shenzhen Oceanwing Smart Innovations Technology Co., Ltd., Shenzhen (CN)

(72) Inventor: Shifang Hu, Shenzhen (CN)

(21) Appl. No.: 19/208,013

(22) Filed: May 14, 2025

(30) Foreign Application Priority Data
May 17, 2024 (CN) 202410622389.7

(51) Int. Cl. G01B 7/30; F16M 11/06; G01B 7/004

(52) U.S. Cl. CPC G01B 7/30; F16M 11/06; G01B 7/004

(57) ABSTRACT

Disclosed are methods, apparatus, systems, and computer-readable media for tripod head position identification. A tripod head may include magnetic induction device(s) and/or a magnetic element. The magnetic element may rotate relative to the magnetic induction device(s). A target magnetic pole of the magnetic element may have an initial position. Tripod head position identification may be performed by obtaining a first magnetic field strength sensed by magnetic induction device(s); determining a current position of the target magnetic pole based on magnetic field strength(s); and/or determining an actual rotation angle of the tripod head based on the initial position and the current position of the target magnetic pole. A rotation angle may be determined by a difference of relative magnetic field strengths of two magnetic induction devices.

### CROSS-REFERENCE TO RELATED APPLICATION

The present application claims priority to Chinese Patent Application No. 202410622389.7, filed on May 17, 2024, which is herein incorporated by reference by its entirety.

### FIELD

The present disclosure relates to the technical field of tripod head rotation and positioning. For example, aspects described herein may relate to tripod head position identification and an electronic device that can perform tripod head position identification.

### BACKGROUND

A tripod head is a device that can rotate in horizontal and vertical directions, and may be used for mounting observation equipment such as cameras and telescopes. Tripod heads are often used in in security cameras. To implement rotation and positioning of the tripod head, a security camera might need to know the accurate position where the tripod head is located.

A professional security camera may use a Hall switch as a position calibration point. The tripod head may be directly driven by a large stepper motor equipped with a synchronous pulley. After zero calibration is completed, rotation angles may be calculated by calculating the number of motor rotation steps by a program for the subsequent positions. However, when zero shift occurs, zero calibration cannot be performed in time, which may lead to errors in detection results. A tripod head of a security camera might additionally and/or alternatively adopt a mechanical locked-rotor method for zeroing. Most motors are driven by reduction stepper motors, and a fit of multi-stage reduction gears with structural members leads to poor precision of the tripod head.

### SUMMARY

The present disclosure may provide a tripod head position identification method and an electronic device. Aspects described herein may solve conventional issues with tripod heads, such as that the tripod heads may have low precision and can be prone to errors.

The present disclosure may provide a tripod head position identification method, in which the tripod head includes a first magnetic induction device, a second magnetic induction device, and/or a magnetic element. The magnetic element may rotate relative to the first magnetic induction device and the second magnetic induction device, and/or a target magnetic pole of the magnetic element may have an initial position. The method may comprise obtaining a first magnetic field strength sensed by the first magnetic induction device and a second magnetic field strength sensed by the second magnetic induction device; determining a current position of the target magnetic pole that is N pole or S pole of the magnetic element based on the first magnetic field strength and the second magnetic field strength; and/or determining an actual rotation angle of the tripod head based on the initial position and the current position of the target magnetic pole.

The determining a current position of the target magnetic pole of the magnetic element based on the first magnetic field strength and the second magnetic field strength may comprise obtaining a relative position between the first magnetic induction device and the second magnetic induction device; calculating a relative angle, which is an angle of the target magnetic pole relative to the first magnetic induction device or the second magnetic induction device, based on the first magnetic field strength and the second magnetic field strength; and/or determining the current position of the target magnetic pole based on the relative angle and the relative position.

The calculating a relative angle of the target magnetic pole based on the first magnetic field strength and the second magnetic field strength may comprise determining a target quadrant of the target magnetic pole in a quadrant coordinate system based on the relative position; calculating a coordinate position of the target magnetic pole in the target quadrant based on the first magnetic field strength and the second magnetic field strength; and/or determining a relative angle of the target magnetic pole based on the coordinate position and the relative position.

The calculating a coordinate position of the target magnetic pole in the target quadrant based on the first magnetic field strength and the second magnetic field strength may comprise obtaining a first voltage value based on the first magnetic field strength to obtain a first coordinate of the target magnetic pole in the target quadrant; and/or obtaining a second voltage value based on the second magnetic field strength to obtain a second coordinate of the target magnetic pole in the target quadrant; and/or obtaining the coordinate position based on the first coordinate and the second coordinate.

The determining a relative angle of the target magnetic pole based on the coordinate position and the relative position may comprise calculating an angle difference between the coordinate position and a coordinate axis where the first magnetic induction device is located or a coordinate axis where the second magnetic induction device is located based on an arctangent function; and/or determining the relative angle of the target magnetic pole based on the angle difference.

The determining an actual rotation angle of the tripod head based on the initial position and the current position of the target magnetic pole may comprise obtaining a first angle between the current position of the target magnetic pole and the first magnetic induction device, and/or a second angle between the initial position of the target magnetic pole and the first magnetic induction device; and/or obtaining a first angle between the current position of the target magnetic pole and the second magnetic induction device, and/or a second angle between the initial position of the target magnetic pole and the second magnetic induction device; and/or determining an actual rotation angle of the tripod head based on the first angle and the second angle.

The determining an actual rotation angle of the tripod head based on the first angle and the second angle may comprise, in response to the second angle greater than zero, calculating a sum of the first angle and the second angle to obtain the actual rotation angle of the tripod head; and/or, in response to the second angle equal to zero, determining the first angle as the actual rotation angle of the tripod head.

Aspects described herein may also provide an electronic device configured to implement one or more steps of the tripod head position identification method as described above, including a first magnetic induction device, a second magnetic induction device, and/or a magnetic element, in which the magnetic element rotates relative to the first magnetic induction device and the second magnetic induction device.

The first magnetic induction device and/or the second magnetic induction device may be disposed close to the target magnetic pole of the magnetic element, and/or an included angle between a connection line between the first magnetic induction device and a central point of the magnetic element and a connection line between the second magnetic induction device and the central point of the magnetic element may be 90°.

The magnetic element may be an annular magnet, at a center of which a cable through hole is formed, and the magnetic element may be radially magnetized.

The first magnetic field strength and second magnetic field strength of a magnetic element rotated may be obtained through a first magnetic induction device and/or a second magnetic induction device. A current position of a target magnetic pole with the strongest magnetic field strength of the magnetic element may be further determined based on the first magnetic field strength and/or the second magnetic field strength, and/or an actual rotation angle of a tripod head may be determined based on the current position and an initial position of the target magnetic pole. The rotation angle of the position with the strongest magnetic field strength of the magnetic element may be determined through a magnetic field strength difference (e.g., the current position of the target magnetic pole of the magnetic element which may characterize the rotation angle of the target magnetic pole, For example, the first magnetic field strength and the second magnetic field strength obtained), and may detect the rotation angle of the tripod head in high precision and in a range of 0° to 360°. Moreover, since the rotation angle of the target magnetic pole of the magnetic element may be determined through the relative magnetic field strength of the magnetic element, when the magnetic element is demagnetized, the magnetic field strength of the magnetic element is uniformly demagnetized, the relative magnetic field strength might not be affected by the magnetic field strength of the magnetic element, and therefore the detection precision of the rotation angle of the tripod head in the present disclosure might not be affected. Since the rotation angle is calculated through the magnetic field strength difference, there might be no need for multiple zeroing or secondary calibration, and the efficiency and accuracy of detection are improved.

It should be understood that both the foregoing general description and the following detailed description are exemplary and explanatory only and are do not limit the disclosure.

### BRIEF DESCRIPTION OF THE DRAWINGS

In order to more clearly illustrate technical solutions in examples of the present disclosure, drawings are briefly introduced below. The drawings in the following description are only some examples of the disclosure, and other drawings can be obtained in accordance with these drawings without inventive work.

FIG. 1 is a flowchart illustrating a tripod head position identification method of the present disclosure;

FIG. 2 is a specific flowchart illustrating an example of step S12 in FIG. 1;

FIG. 3 is a specific flowchart illustrating an example of step S122 in FIG. 2;

FIG. 4 is a specific flowchart illustrating an example of step S1222 in FIG. 3;

FIG. 5 is a specific flowchart illustrating an example of step S1223 in FIG. 3;

FIG. 6 is a specific flowchart illustrating an example of step S13 in FIG. 1;

FIG. 7 is a structure diagram illustrating an example of an electronic device;

FIG. 8 illustrates a measurement result of an electronic device;

FIG. 9 is a block diagram illustrating an example of an electronic device; and

FIG. 10 is a block diagram illustrating an example of a computer-readable storage medium.

### DETAILED DESCRIPTION

A tripod head position identification method and an electronic device are described in further detail below. The examples as described herein are only some of the examples, rather than all the examples of the present disclosure. Based on the examples in the present disclosure, all other examples obtained by one skilled in the art without involving inventive work fall within the protection scope of the present disclosure.

The terms “first”, “second”, and the like in the disclosure are used to distinguish different objects but need not describe a particular order. Furthermore, the terms “comprising” and “including” and any variations thereof may cover non-exclusive inclusion. For example, a process, method, system, product, or device including a series of steps or elements is not necessarily limited to the steps or elements listed, but may optionally include other steps or elements inherent to the process, method, product, or device.

A security camera may be used to detect an area within a target range. In turn, the security camera may be configured to rotate within a certain range. To rotate, the security camera may use a tripod head. One function of the tripod head ay be to enable a device mounted thereon, such as the security camera, to achieve precise orientation and tracking.

Existing security cameras may calculate a stay position of a tripod head by zeroing and counting steps with a stepper motor. Different products may use different motors and structure fitting members, which may result in different precision of different tripod heads. Some security cameras may have a problem of errors in detection results caused by zero shift, and some security cameras have a problem of low detection precision caused by a complex physical structure.

In order to solve technical problems such as those described above, the present disclosure may provide a tripod head position identification method that may be applied to different security cameras. Two magnetic induction devices may be used to detect different magnetic field strengths of a magnetic element in the tripod head. A rotation angle of the tripod head may be calculated by calculating a difference in the magnetic field strengths. This may enable high-precision detection of 0° to 360° and may improve efficiency and accuracy of detection of the rotation angle of the tripod head without a need for multiple zeroing or calibration.

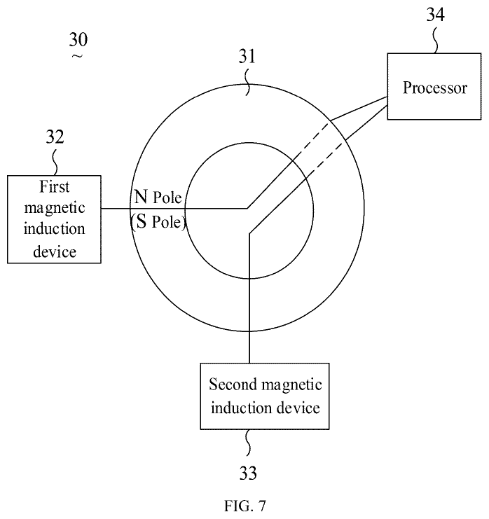

In the present disclosure, an execution subject of the tripod head position identification method may be an electronic device, as specifically illustrated in FIG. 7. FIG. 7 comprises a structure diagram illustrating an example of the electronic device of the present disclosure. In the example, an electronic device 30 may include a magnetic element 31, a first magnetic induction device 32, and/or a second magnetic induction device 33. The first magnetic induction device 32 and/or the second magnetic induction device 33 may be disposed close to a target magnetic pole of the magnetic element 31. An included angle between a connection line between the first magnetic induction device 32 and a central point of the magnetic element 31 and a connection line between the second magnetic induction device 33 and the central point of the magnetic element 31 may be 90°.

The material of the magnetic element 31 may be a magnetic material, such as ferrite or neodymium iron boron. Different magnetic materials may be selected according to considerations such as production cost or battery life.

The first magnetic induction device 32 may be disposed close to the target magnetic pole of the magnetic element 31. The first magnetic induction device 32 may be disposed on the side of N pole of the magnetic element 31 and/or on the side of S pole of the magnetic element 31. The included angle between the connection line between the first magnetic induction device 32 and the central point of the magnetic element 31 and the connection line between the second magnetic induction device 33 and the central point of the magnetic element 31 may be 90°.

The magnetic element 31 may be an annular magnet and is radially magnetized, where radial magnetization might mean that the magnetizing direction of magnetic steel and the magnetic field direction are both distributed along the radial direction. Further, the magnetic element 31 in the example may be a single-magnetic pole element.

Specifically, the first magnetic induction device 32 may be disposed at a position close to the target magnetic pole of the magnetic element 31. The magnetic field strength at the position of the first magnetic induction device 32 may be the strongest. For example, the magnetic field strength of the N pole of the magnetic element 31 may be the strongest, and may gradually decreases toward the S pole until the weakest magnetic field strength of the S pole of the magnetic element 31, and the magnetic field strength at the position of the second magnetic induction device 33 is zero. Additionally and/or alternatively, the magnetic field strength of the S pole of the magnetic element 31 may be the strongest, and may gradually decreases toward the N pole until the weakest magnetic field strength of the N pole of the magnetic element 31, and the magnetic field strength at the position of the second magnetic induction device 33 is zero.

The magnetic element 31 may be magnetized in other manners, as long as the magnetic field of the magnetic element 31 changes according to rules.

A cable through hole may be formed at a center of the annular magnet, and a cable for electric connection in the electronic device 30 may pass through the cable through hole, so that a cable layout of the electronic device 30 is neat.

Further, the electronic device 30 in the example may further include a processor 34 and/or a device body. The processor 34 may be electrically connected to the first magnetic induction device 32 and the second magnetic induction device 33 through cables, so as to receive a first magnetic field strength and a second magnetic field strength sensed by the first magnetic induction device 32 and the second magnetic induction device 33 and/or perform further processing on the first magnetic field strength and the second magnetic field strength. The processor 34 may include a microcontroller unit (MCU) or a central processing unit (CPU).

The first magnetic induction device 32 and the second magnetic induction device 33 may be disposed on two sides of the cable through hole of the annular magnet, and both may be disposed on a side of the annular magnet close to the device body. The processor 34 may be disposed on a side of the annular magnet away from the device body, For example, the processor may be in a height direction of the electronic device 30. The first magnetic induction device 32 along with the second magnetic induction device 33 and/or the processor 34 may be respectively disposed on two sides of the annular magnet. The device body may be specifically a camera body which may be electrically connected to the processor 34 through a cable.

Through the above arrangement, an original cable layout of connection from a side may be changed to a layout of connection through a central through hole. When the electronic device 30 rotates, interference between cables at the side and the annular magnet or other components may be avoided. Moreover, entanglement of multiple bundles of cables in different directions during rotation may be reduced, thereby preventing excessive stretching of part of the cables, increasing service life of the cables, and reducing rotational damping of the tripod head.

The electronic device 30 may further include a housing and/or a camera body disposed on the housing. The magnetic element 31, the first magnetic induction device 32, the second magnetic induction device 33, and/or the processor 34 may all be disposed inside the housing and may collectively serve as a tripod head positioning mechanism. The camera body may be mounted on the housing through the tripod head positioning mechanism, and the electronic device 30 may implement rotation and positioning of the camera body through the tripod head positioning mechanism.

The tripod head position identification method may be implemented by a processor invoking computer-readable instructions stored in a memory.

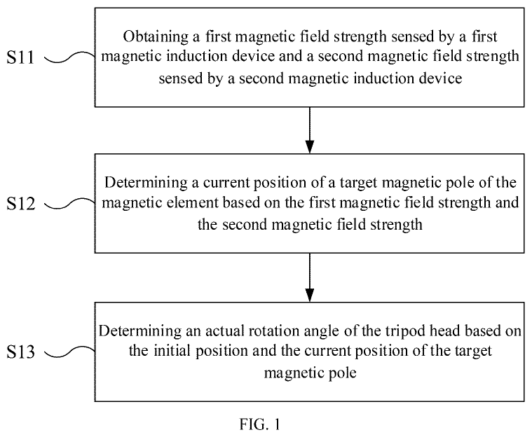

FIG. 1 is a flowchart illustrating an example of tripod head position identification. Specifically, a tripod head position identification method may include one or more of the following steps S11 to S13.

Step S11 may comprise obtaining a first magnetic field strength sensed by the first magnetic induction device and a second magnetic field strength sensed by the second magnetic induction device.

The first magnetic field strength of the magnetic element 31 after rotation may be obtained through the first magnetic induction device 32. The first magnetic field strength may be specifically the magnetic field strength of the N pole of the magnetic element 31, the magnetic field strength of the S pole of the magnetic element 31, and/or the magnetic field strength at any point of the magnetic element 31.

The first magnetic induction device 32 may include a linear Hall effect device and/or a digital Hall effect sensor. For example, if the first magnetic induction device 32 is the linear Hall device, the first magnetic induction device 32 may be connected to the processor 34 through an ADC interface. As another example, if the first magnetic induction device 32 is the digital Hall sensor, the first magnetic induction device 32 may communicate with the processor 34 through an analog signal.

The second magnetic field strength of the magnetic element 31 after rotation may be obtained through the second magnetic induction device 33. The magnetic field strength difference between the second magnetic field strength and the first magnetic field strength may be equal to the magnetic field strength difference corresponding to a 90° rotation angle in the magnetic field.

The second magnetic induction device 33 may include a linear Hall effect device or a digital Hall effect sensor. For example, if the second magnetic induction device 33 is the linear Hall device, the second magnetic induction device 33 may be connected to the processor 34 through an ADC interface. As another example, if the second magnetic induction device 33 is the digital Hall sensor, the second magnetic induction device 33 may communicate with the processor 34 through an analog signal.

Positions of the first magnetic induction device 32 and the second magnetic induction device 33 may be interchangeable. The second magnetic induction device 33 may be used to detect the magnetic field strength at the N pole, the S pole, or any point of the magnetic element 31, and the first magnetic induction device 32 may be used to detect the magnetic field strength corresponding to a rotation angle difference of 90° of the second magnetic induction device 33.

The first magnetic induction device 32 and the second magnetic induction device 33 may be combined in a variety of ways. For example, the first magnetic induction device 32 may be a linear Hall effect device, and the second magnetic induction device 33 may be a digital Hall effect sensor; and/or the first magnetic induction device 32 may be a digital Hall effect sensor and the second magnetic induction device 33 may be a linear Hall effect device; and/or the first magnetic induction device 32 may be a linear Hall effect device and the second magnetic induction device 33 may be a linear Hall effect device; and/or the first magnetic induction device 32 may be a digital Hall effect sensor and the second magnetic induction device 33 may be a digital Hall effect sensor, and the like.

Step S12 may comprise determining a current position of a target magnetic pole of the magnetic element based on the first magnetic field strength and the second magnetic field strength. The target magnetic pole of the magnetic element 31 may be specifically the N pole or the S pole, which is a magnetic pole of the magnetic element 31 having the strongest magnetic field strength.

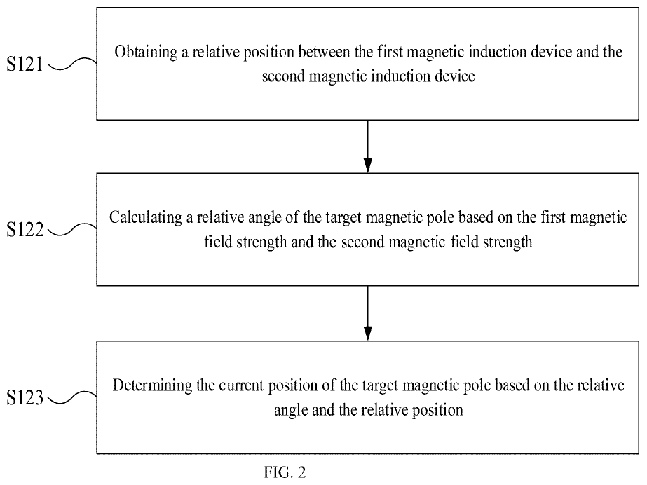

Further, a specific process of determining a current position of the target magnetic pole of the magnetic element may be based on the first magnetic field strength and the second magnetic field strength is depicted in FIG. 2. FIG. 2 is a specific flowchart that may illustrate an example of step S12 in FIG. 1. The process depicted in FIG. 2 includes the following steps S121 to S123.

Step S121 may comprise obtaining a relative position between the first magnetic induction device and the second magnetic induction device. The relative position between the first magnetic induction device 32 and the second magnetic induction device 33 may be obtained, and it may be specifically determined that a direction of a connection line between the first magnetic induction device 32 and the central point of the magnetic element 31 is perpendicular to a direction of a connection line between the second magnetic induction device 33 and the central point of the magnetic element 31.

Step S122 may comprise calculating a relative angle of the target magnetic pole based on the first magnetic field strength and the second magnetic field strength. The relative angle may refer to an angle of the target magnetic pole of the magnetic element 31 relative to the first magnetic induction device 32 or the second magnetic induction device 33.

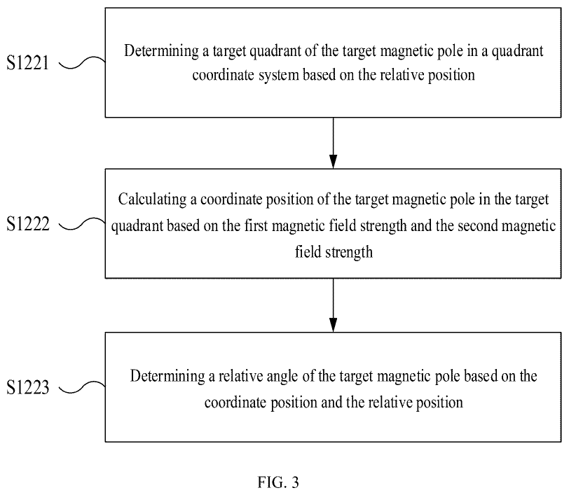

Further, a specific process of calculating the relative angle of the target magnetic pole based on the first magnetic field strength and the second magnetic field strength may be depicted in FIG. 3. FIG. 3 is a specific flowchart illustrating an example of, for example, step S122 in FIG. 2. FIG. 3 depicts steps S1221 to S1223.

Step S1221 may comprise determining a target quadrant of the target magnetic pole in a quadrant coordinate system based on the relative position. The relative position obtained based on step S121 may determine that magnetic field directions of the first magnetic induction device 32 and the second magnetic induction device 33 are perpendicular to each other. Therefore, the magnetic field strength of the second magnetic induction device 33 may be used as a second coordinate axis of the quadrant coordinate system, and/or the magnetic field strength of the first magnetic induction device 32 may be used as a first coordinate axis of the quadrant coordinate system. The target quadrant of the target magnetic pole in the quadrant coordinate system may be determined in response to a sign of the magnetic field strength.

Step S1222 may comprise calculating a coordinate position of the target magnetic pole in the target quadrant based on the first magnetic field strength and the second magnetic field strength. The coordinate position of the target magnetic pole in the target quadrant determined in step S1221 may be calculated based on the first magnetic field strength and the second magnetic field strength.

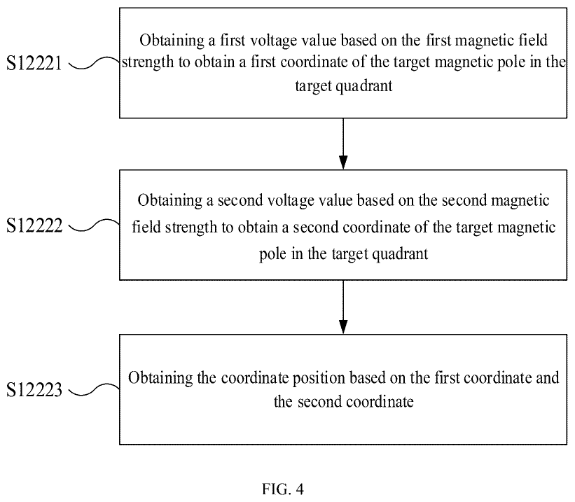

A specific process of calculating the coordinate position of the target magnetic pole in the target quadrant based on the first magnetic field strength and the second magnetic field strength is depicted in FIG. 4. FIG. 4 is a specific flowchart illustrating an example of, for example, step S1222 in FIG. 3. FIG. 4 includes the following steps S12221 to S12223.

Step S12221 may comprise obtaining a first voltage value based on the first magnetic field strength to obtain a first coordinate of the target magnetic pole in the target quadrant. The first magnetic field strength of the magnetic element 31 after rotation may be sensed through the first magnetic induction device 32. For example, if the first magnetic induction device 32 is a voltage-type Hall effect sensor, an output signal thereof may be a voltage signal, and a voltage signal value at present may be specifically a first voltage value. As another example, if the first magnetic induction device 32 in the example is a current-type Hall effect sensor, an output signal thereof may be a current signal. Based on a current signal value at present and a voltage formula, a voltage value at present may be calculated. For example, the calculated value may be a first voltage value. Further, a first coordinate of the target magnetic pole in the target quadrant may be determined based on an absolute value of the first voltage value. For example, a first coordinate axis as well as a positive direction or a negative direction of the target magnetic pole in the first coordinate axis may be determined based on the first magnetic field strength obtained. Further, a specific coordinate value of the target magnetic pole on the first coordinate axis may be determined based on the absolute value of the first voltage value. The first coordinate may be obtained by combining the two.

Step S12222 may comprise obtaining a second voltage value based on the second magnetic field strength to obtain a second coordinate of the target magnetic pole in the target quadrant. The second magnetic field strength of the magnetic element 31 after rotation may be sensed through the second magnetic induction device 33. For example, if the second magnetic induction device 33 is a voltage-type Hall sensor, an output signal thereof may be a voltage signal, and a voltage signal value at present may be specifically a second voltage value. As another example, if the second magnetic induction device 33 in the example is a current-type Hall sensor, an output signal thereof may be a current signal. Based on the current signal value at present and a voltage formula, a voltage value at present may be calculated. For example, the calculated voltage value may comprise a second voltage value. Further, in the example, a second coordinate of the target magnetic pole in the target quadrant may be determined based on an absolute value of the second voltage value. Specifically, a second coordinate axis as well as a positive direction or a negative direction of the target magnetic pole on the second coordinate axis may be determined based on the second magnetic field strength obtained. Further, a specific coordinate value of the target magnetic pole on the second coordinate axis may be determined based on the absolute value of the second voltage value. The second coordinate may be obtained by combining the two.

Step S12223 may comprise obtaining the coordinate position based on the first coordinate and the second coordinate. A unique coordinate of the target magnetic pole in the target quadrant may be determined based on the first coordinate and the second coordinate. For example, the coordinate position of the target magnetic pole may be obtained. For example, if the first coordinate is determined to be x1 and the second coordinate is determined to be x2, the coordinate position of the target magnetic pole can be determined as (x1, x2).

An initial position of the first magnetic induction device 32 may be taken as a positive direction of X-axis, and an initial position of the second magnetic induction device 33 may be taken as a positive direction of Y-axis. Since the magnetic field strength has positive and negative values, the first voltage value measured by the first magnetic induction device 32 may have positive and negative values, and the second voltage value measured by the second magnetic induction device 33 may also have positive and negative values. A target quadrant may be determined by the first magnetic induction device 32 and the second magnetic induction device 33, and may be a first quadrant, a second quadrant, a third quadrant, and/or a fourth quadrant in a quadrant coordinate system. A coordinate position of the target magnetic pole in the target quadrant may be determined based on specific values of the first voltage value and the second voltage value. Therefore, the tripod head position identification method in the example may achieve detection in a range of 0° to 360°.

Step S1223 may comprise determining a relative angle of the target magnetic pole based on the coordinate position and the relative position. The relative angle of the target magnetic pole may be calculated based on the relative position determined in step S1221 and the coordinate position determined in step S1222. The relative angle is an angle of the target magnetic pole may be relative to the first magnetic induction device 32 or the second magnetic induction device 33. For example, the first magnetic induction device 32 may be initially disposed at the target magnetic pole of the magnetic element 31, and the magnetic field strength at the position of the first magnetic induction device 32 may be regarded as the strongest magnetic field strength of the magnetic element 31. Therefore, the relative angle in the example may be specifically an angle of the target magnetic pole relative to the first magnetic induction device 32. For example, a relative rotation angle of the magnetic pole having the strongest magnetic field strength of the magnetic element 31 may be determined.

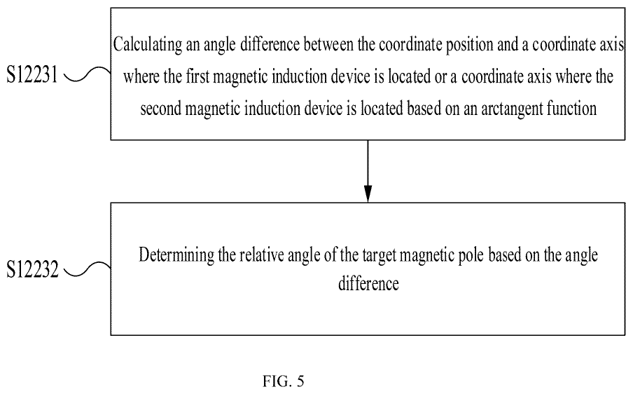

Further, a specific process of determining the relative angle of the target magnetic pole based on the coordinate position and the relative position may be depicted in FIG. 5. FIG. 5 is a specific flowchart illustrating, for example, step S1223 in FIG. 3. FIG. 5 may comprise one or more of steps S12231 to S12232.

Step S12231 may comprise calculating an angle difference between the coordinate position and a coordinate axis where the first magnetic induction device is located or a coordinate axis where the second magnetic induction device is located based on an arctangent function.

Step S12232 may comprise determining the relative angle of the target magnetic pole based on the angle difference. A calculation formula of the arctangent function may be specifically as follows:

$$ret = ( arctan ( tmp 1 , tmp 2 ) * val + 180 ) * 10$$

$$val = 1800000 / 31415$$

In the formula, ret may be an angle difference obtained by calculation, arctan( ) may be an arctangent function, tmp1 may be a first voltage value (e.g., a specific coordinate value of the target magnetic pole on the first coordinate axis), tmp2 may be a second voltage value (e.g., a specific coordinate value of the target magnetic pole on the second coordinate axis), and/or val may be an angle conversion parameter (e.g., a conversion parameter between x and angle).

The angle difference between the first voltage value tmp1 and the second voltage value tmp2 may be calculated through the arctangent function arctan( ) such as an angle difference between the coordinate position of the target magnetic pole and any one of the coordinate axes.

A product of the angle difference ret and the angle conversion parameter val may be further calculated, so as to obtain an included angle between the coordinate position of the target magnetic pole and the X-axis or the Y-axis (e.g., an included angle between a connection line between the coordinate position of the target magnetic pole and an origin of the quadrant coordinate system and the first coordinate axis of the first magnetic induction device 32 or the second coordinate axis of the second magnetic induction device 33). The included angle may be the relative angle of the target magnetic pole.

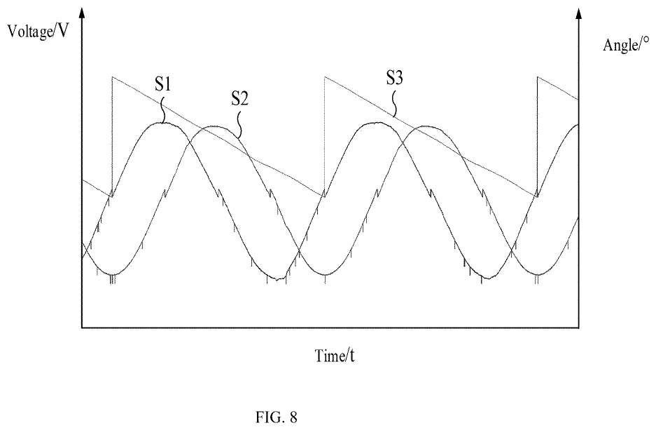

An example measurement result diagram of the electronic device 30 is shown in FIG. 8. FIG. 8 illustrates a measurement result of the electronic device. As shown in FIG. 8, a curve S1 may represent the first voltage value tmp1 measured by the first magnetic induction device 32, a curve S2 may represent the second voltage value tmp2 measured by the second magnetic induction device 33, and/or a curve S3 may represent the relative angle of the target magnetic pole of the magnetic element 31 (e.g., a rotation angle of the target magnetic pole of the magnetic element 31 relative to the first magnetic induction device 32 and/or the second magnetic induction device 33).

Step S123 may comprise determining the current position of the target magnetic pole based on the relative angle and the relative position. The current position of the target magnetic pole may be determined based on the relative position between the first magnetic induction device and the second magnetic induction device obtained in step S121 and/or the relative angle of the target magnetic pole obtained in step S122. The current position may be a position of the target magnetic pole in a world coordinate system.

Step S13 may comprise determining an actual rotation angle of the tripod head based on the initial position and the current position of the target magnetic pole. When the tripod head leaves factory, since it is impossible to ensure that the first magnetic induction device 32 is exactly disposed at the position corresponding to the target magnetic pole (e.g., a position where the magnetic field of the magnetic element 31 is the strongest during installation, as it is impossible to ensure that the initial position of the target magnetic pole of the magnetic element 31 in each tripod head is consistent), calibration may be performed for the target magnetic pole to determine the initial position of the target magnetic pole. The initial position of the target magnetic pole may be specifically calibrated based on the relative positional relationship with the first magnetic induction device 32 fixedly disposed.

A magnetic field strength at the initial position of the target magnetic pole and a first initial magnetic field strength sensed by the first magnetic induction device 32 may be obtained, and the relative angle between the initial position of the target magnetic pole and the first magnetic induction device 32 may be calculated using the arctangent function. Specific calculation steps can be as shown in, for example, step S121 to step S122. Further, the relative angle between the initial position of the target magnetic pole and the first magnetic induction device 32 may be stored by the processor 34.

The initial position of the target magnetic pole may be defined as a first calibration position, and a position where the magnetic field strength of the magnetic element 31 is weakest may be obtained as a second calibration position, where an included angle between a connection line between the first calibration position and the central point of the magnetic element 31 and a connection line between the second calibration position and the central point of the magnetic element 31 may be 90°.

The first calibration position and the second calibration position may be specific positions of the magnetic element 31 calibrated by a manufacturer. When the magnetic element 31 is installed, the position of the first magnetic induction device 32 may diverge from the first calibration position, and the position of the second magnetic induction device 33 may diverge from the second calibration position. Therefore, it may be beneficial to calibrate both the first calibration position and the second calibration position. The first calibration position of the target magnetic pole may be calibrated based on the relative positional relationship with the first magnetic induction device 32 fixedly disposed, and the second calibration position of the target magnetic pole may be calibrated based on the relative positional relationship with the second magnetic induction device 33 fixedly disposed.

Further, the magnetic field strength at the initial position of the target magnetic pole, the first initial magnetic field strength sensed by the first magnetic induction device 32, and/or the second initial magnetic field strength sensed by the second magnetic induction device 33 may be obtained. The first relative angle between the first calibration position of the target magnetic pole and the first magnetic induction device 32 may be calculated using the arctangent function, and the second relative angle between the second calibration position of the target magnetic pole and the second magnetic induction device 33 may be calculated using the arctangent function. Specific calculation steps may be as shown in, for example, step S121 to step S122. Further, a difference between an actual magnetic field and a calibration magnetic field may be determined based on the first relative angle and the second relative angle, which may be specifically caused by an abnormality during assembly of the magnetic element 31 to the tripod head.

The first calibration position of the target magnetic pole and the first relative angle of the first magnetic induction device 32, as well as the second calibration position of the target magnetic pole and the second relative angle of the second magnetic induction device 33, may be stored by the processor 34.

The calibration of the magnetic element 31 may be completed by the manufacturer. During specific operation of the electronic device 30, an actual rotation value of the tripod head may be obtained by determining a measured rotation value of the tripod head and converting the measured rotation value based on the difference between the actual magnetic field and the calibration magnetic field. Multiple calibrations or zeroing need not be required during the measurement process, which can improve the detection efficiency and accuracy of the rotation angle of the tripod head.

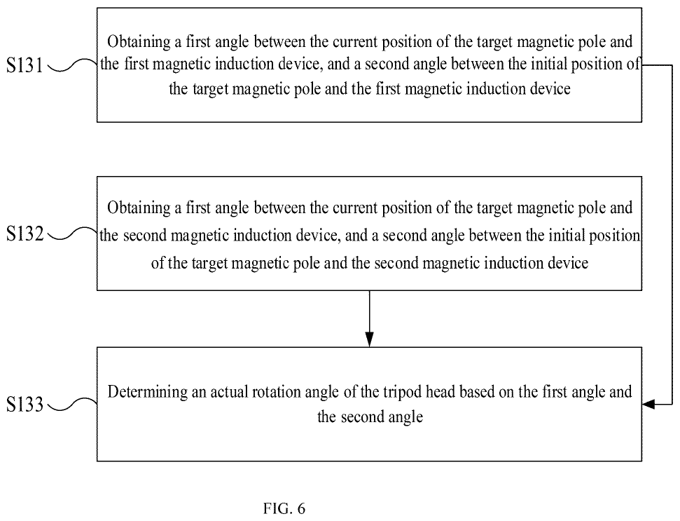

Further, the actual rotation angle of the entire tripod head may be determined based on the initial position and the current position of the target magnetic pole determined by, e.g., the above method. A specific process of determining the actual rotation angle of the tripod head based on the initial position and the current position of the target magnetic pole is depicted in FIG. 6. FIG. 6 is a specific flowchart illustrating, for example, step S13 in FIG. 1. FIG. 6 may comprise one or more of the following steps.

Step S131 may comprise obtaining a first angle between the current position of the target magnetic pole and the first magnetic induction device, and a second angle between the initial position of the target magnetic pole and the first magnetic induction device.

Step S132 may comprise obtaining a first angle between the current position of the target magnetic pole and the second magnetic induction device, and a second angle between the initial position of the target magnetic pole and the second magnetic induction device.

Step S133 may comprise determining an actual rotation angle of the tripod head based on the first angle and the second angle. The actual rotation angle of the target magnetic pole may be determined based on the first angle obtained in step S131 or step S132, and the difference between the current actual magnetic field and the calibration magnetic field (or an ideal magnetic field) may be determined based on the second angle obtained in step S131 or step S132. The actual rotation angle of the tripod head may be determined based on a sum of the two.

Based on the second angle being greater than zero, a sum of the first angle and the second angle may be calculated to obtain the actual rotation angle of the tripod head. Based on the second angle being equal to zero, the first angle may be determined as the actual rotation angle of the tripod head.

The rotation angle of the target magnetic pole may be determined based on a difference in magnetic field strengths sensed by the first magnetic induction device and/or the second magnetic induction device, which might focus on the magnetic field strength difference, but need not be affected by a calibration value, thereby enabling high-precision detection of the rotation angle of the tripod head without limit of a physical structure, and thus enabling detection in a range of 0° to 360°. At the same time, sensing relative magnetic field strength of the magnetic element 31 may improve detection accuracy and extend the service life of the electronic device 30. The demagnetization of the magnetic element 31, which might occur over prolonged use, might only affect the magnetic field strength of the magnetic element. Moreover, the magnetic field strength of the magnetic element may be uniformly reduced due to the demagnetization. Therefore, the demagnetization of the magnetic element 31 might have little or no impact on the measurement accuracy.

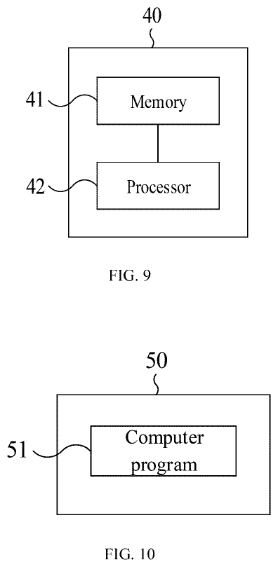

Aspects described herein also relate to an electronic device. Referring to FIG. 9, FIG. 9 comprises a block diagram illustrating an example of the electronic device. An electronic device 40 may include a memory 41 and/or a processor 42 that are coupled to each other. The processor 42 may be configured to execute program instructions stored in the memory 41 to implement one or more of the steps detailed herein. For example, the electronic device 40 may include but is not limited to a microcomputer and a server. In addition, the electronic device 40 may further include mobile devices such as a laptop or a tablet.

The processor 42 may be configured to control itself and/or the memory 41 to implement one or more of the steps described herein. The processor 42 may also be referred to as a central processing unit (CPU). The processor 42 may be an integrated circuit chip with a signal processing capability. The processor 42 may also be a general processor, a digital signal processor (DSP), an application specific integrated circuit (ASIC), a field programmable gate array (FPGA), and/or other programmable logic devices, discrete gate or transistor logic devices, and/or discrete hardware components. The general processor may be a microprocessor and/or any conventional processor. In addition, the processor 42 may be implemented along with an integrated circuit chip.

Aspects described herein also relate to a computer-readable storage medium. Referring to FIG. 10, FIG. 10 is a block diagram illustrating an example of the computer-readable storage medium. A computer-readable storage medium 50 may store a computer program 51 that may be executed by a processor and may be configured to implement one or more of the steps detailed herein.

A function or a module of the device provided in the examples of the present disclosure may be used to execute the method described in the above examples, and specific implementation thereof can refer to the description of the above method examples. The foregoing examples describe differences between the examples, and the same or similar parts can refer to each other, which will not be repeated herein for brevity.

In the several examples provided in the present disclosure, the disclosures can be implemented in a wide variety of ways. The above-described examples of the device are only schematic, for example, division of the units is only logical function division, and there may be other ways of division in actual implementation. For example, the units or components described herein may be combined or integrated into another system, and/or some features can be ignored and/or not executed. Moreover, mutual coupling or direct coupling or communication connection shown or discussed may be indirect coupling or communication connection through some communication interfaces, devices or units, and may be in electrical, mechanical or other forms.

The functional units in the examples of the present disclosure may be integrated in one processing unit, and/or the functional units may be present separately physically, and/or two or more functional units may be integrated into one unit. The integrated unit may be implemented in a form of hardware or in a form of a software functional unit.

When the integrated unit is realized in the form of a software functional unit and sold or used as an independent product, the integrated unit may be stored in a computer-readable storage medium. Based on this understanding, the technical solutions of the present disclosure essentially or the part that contributes to the prior art or all or part of the technical solutions may be embodied in the form of a software product which is stored in a storage medium and may include several instructions to cause a computer device (which may be a mobile phone, a personal computer, a server, a network device, or the like) and/or a processor to execute all or part of steps of the method described in the examples of the disclosure. The above storage medium may include various media capable of storing program codes such as a USB flash disk, a mobile hard disk, a read-only memory (ROM), a random access memory (RAM), a magnetic disk, and/or an optical disk.

The various examples provided above are not intended to limit the present disclosure. Transformation of an equivalent structure or process made with the contents of the specification and drawings of the present disclosure may be directly or indirectly used in other related technical fields, and should be included in the protection scope of the present disclosure.

What is claimed is:

1. A tripod head position identification method comprising:
obtaining, via a first magnetic induction device of a tripod head, a first magnetic field strength;
obtaining, via a second magnetic induction device of the tripod head, a second magnetic field strength;
determining, based on the first magnetic field strength and the second magnetic field strength, a current position of a target magnetic pole of the tripod head, wherein the current position comprises a north pole or a south pole of a magnetic element configured to rotate relative to the first magnetic induction device and the second magnetic induction device; and
determining, based on an initial position of the target magnetic pole and the current position of the target magnetic pole, an actual rotation angle of the tripod head.

2. The tripod head position identification method of claim 1, wherein the determining the current position of the target magnetic pole comprises:
obtaining a relative position between the first magnetic induction device and the second magnetic induction device;
calculating, based on the first magnetic field strength and the second magnetic field strength, a relative angle indicating an angle of the target magnetic pole relative to the first magnetic induction device or the second magnetic induction device; and
determining, based on the relative angle and the relative position, the current position of the target magnetic pole.

3. The tripod head position identification method of claim 1, wherein the determining the current position of the target magnetic pole comprises calculating a relative angle of the target magnetic pole by:
determining, based on a relative position between the first magnetic induction device and the second magnetic induction device, a target quadrant of the target magnetic pole in a quadrant coordinate system;
calculating, based on the first magnetic field strength and the second magnetic field strength, a coordinate position of the target magnetic pole in the target quadrant; and
determining a relative angle of the target magnetic pole based on the coordinate position and the relative position.

4. The tripod head position identification method of claim 1, wherein the determining the current position of the target magnetic pole comprises calculating a coordinate position of the target magnetic pole by:
obtaining a first voltage value based on the first magnetic field strength to obtain a first coordinate of the target magnetic pole in a target quadrant of a quadrant coordinate system;
obtaining a second voltage value based on the second magnetic field strength to obtain a second coordinate of the target magnetic pole in the target quadrant; and
obtaining the coordinate position based on the first coordinate and the second coordinate.

5. The tripod head position identification method of claim 1, wherein the determining the current position of the target magnetic pole comprises determining a relative angle of the target magnetic pole by:
calculating an angle difference between a coordinate position and a coordinate axis, wherein the first magnetic induction device is located or a coordinate axis, and wherein the second magnetic induction device is located based on an arctangent function; and
determining, based on the angle difference, the relative angle of the target magnetic pole.

6. The tripod head position identification method of claim 1, wherein the determining the actual rotation angle of the tripod head comprises:
one of:
obtaining a first angle between the current position of the target magnetic pole and the first magnetic induction device and a second angle between the initial position of the target magnetic pole and the first magnetic induction device; or
obtaining a first angle between the current position of the target magnetic pole and the second magnetic induction device, and a second angle between the initial position of the target magnetic pole and the second magnetic induction device; and
determining, based on the first angle and the second angle, an actual rotation angle of the tripod head.

7. The tripod head position identification method of claim 1, wherein the determining the current position of the target magnetic pole comprises determining an actual rotation angle of the tripod head by one of:
based on a second angle between the initial position of the target magnetic pole and the second magnetic induction device being greater than zero, calculating a sum of a first angle between the current position of the target magnetic pole and the first magnetic induction device and the second angle to obtain the actual rotation angle of the tripod head; or
based on the second angle being equal to zero, determining the first angle as the actual rotation angle of the tripod head.

8. A tripod head comprising:
a first magnetic induction device,
a second magnetic induction device,
one or more processors, and
memory storing instructions that, when executed by the one or more processors, cause the tripod head to:
obtain, via the first magnetic induction device of a tripod head, a first magnetic field strength;
obtain, via the second magnetic induction device of the tripod head, a second magnetic field strength;
determine, based on the first magnetic field strength and the second magnetic field strength, a current position of a target magnetic pole of the tripod head, wherein the current position comprises a north pole or a south pole of a magnetic element configured to rotate relative to the first magnetic induction device and the second magnetic induction device; and
determine, based on an initial position of the target magnetic pole and the current position of the target magnetic pole, an actual rotation angle of the tripod head.

9. The tripod head of claim 8, wherein the instructions, when executed by the one or more processors, cause the tripod head to determine the current position of the target magnetic pole comprises:
obtaining a relative position between the first magnetic induction device and the second magnetic induction device;
calculating, based on the first magnetic field strength and the second magnetic field strength, a relative angle indicating an angle of the target magnetic pole relative to the first magnetic induction device or the second magnetic induction device; and
determining, based on the relative angle and the relative position, the current position of the target magnetic pole.

10. The tripod head of claim 8, wherein the instructions, when executed by the one or more processors, cause the tripod head to determine the current position of the target magnetic pole by calculating a relative angle of the target magnetic pole by:
determining, based on a relative position between the first magnetic induction device and the second magnetic induction device, a target quadrant of the target magnetic pole in a quadrant coordinate system;
calculating, based on the first magnetic field strength and the second magnetic field strength, a coordinate position of the target magnetic pole in the target quadrant; and
determining a relative angle of the target magnetic pole based on the coordinate position and the relative position.

11. The tripod head of claim 8, wherein the instructions, when executed by the one or more processors, cause the tripod head to determine the current position of the target magnetic pole by calculating a coordinate position of the target magnetic pole by:
obtaining a first voltage value based on the first magnetic field strength to obtain a first coordinate of the target magnetic pole in a target quadrant of a quadrant coordinate system;
obtaining a second voltage value based on the second magnetic field strength to obtain a second coordinate of the target magnetic pole in the target quadrant; and
obtaining the coordinate position based on the first coordinate and the second coordinate.

12. The tripod head of claim 8, wherein the instructions, when executed by the one or more processors, cause the tripod head to determine the current position of the target magnetic pole by determining a relative angle of the target magnetic pole by:
calculating an angle difference between a coordinate position and a coordinate axis, wherein the first magnetic induction device is located or a coordinate axis, and wherein the second magnetic induction device is located based on an arctangent function; and
determining, based on the angle difference, the relative angle of the target magnetic pole.

13. The tripod head of claim 8, wherein the instructions, when executed by the one or more processors, cause the tripod head to determine the actual rotation angle of the tripod head by:
one of:
obtaining a first angle between the current position of the target magnetic pole and the first magnetic induction device and a second angle between the initial position of the target magnetic pole and the first magnetic induction device; or
obtaining a first angle between the current position of the target magnetic pole and the second magnetic induction device, and a second angle between the initial position of the target magnetic pole and the second magnetic induction device; and
determining, based on the first angle and the second angle, an actual rotation angle of the tripod head.

14. The tripod head of claim 8, wherein the instructions, when executed by the one or more processors, cause the tripod head to determine the current position of the target magnetic pole by determining an actual rotation angle of the tripod head by one of:
based on a second angle between the initial position of the target magnetic pole and the second magnetic induction device being greater than zero, calculating a sum of a first angle between the current position of the target magnetic pole and the first magnetic induction device and the second angle to obtain the actual rotation angle of the tripod head; or
based on the second angle being equal to zero, determining the first angle as the actual rotation angle of the tripod head.

15. One or more non-transitory computer-readable media storing instructions that, when executed by the one or more processors of a tripod head, cause the tripod head to:
obtain, via a first magnetic induction device of a tripod head, a first magnetic field strength;
obtain, via a second magnetic induction device of the tripod head, a second magnetic field strength;
determine, based on the first magnetic field strength and the second magnetic field strength, a current position of a target magnetic pole of the tripod head, wherein the current position comprises a north pole or a south pole of a magnetic element configured to rotate relative to the first magnetic induction device and the second magnetic induction device; and
determine, based on an initial position of the target magnetic pole and the current position of the target magnetic pole, an actual rotation angle of the tripod head.

16. The one or more non-transitory computer-readable media of claim 15, wherein the instructions, when executed by the one or more processors, cause the tripod head to determine the current position of the target magnetic pole comprises:
obtaining a relative position between the first magnetic induction device and the second magnetic induction device;
calculating, based on the first magnetic field strength and the second magnetic field strength, a relative angle indicating an angle of the target magnetic pole relative to the first magnetic induction device or the second magnetic induction device; and
determining, based on the relative angle and the relative position, the current position of the target magnetic pole.

17. The one or more non-transitory computer-readable media of claim 15, wherein the instructions, when executed by the one or more processors, cause the tripod head to determine the current position of the target magnetic pole by calculating a relative angle of the target magnetic pole by:
determining, based on a relative position between the first magnetic induction device and the second magnetic induction device, a target quadrant of the target magnetic pole in a quadrant coordinate system;
calculating, based on the first magnetic field strength and the second magnetic field strength, a coordinate position of the target magnetic pole in the target quadrant; and
determining a relative angle of the target magnetic pole based on the coordinate position and the relative position.

18. The one or more non-transitory computer-readable media of claim 15, wherein the instructions, when executed by the one or more processors, cause the tripod head to determine the current position of the target magnetic pole by calculating a coordinate position of the target magnetic pole by:
obtaining a first voltage value based on the first magnetic field strength to obtain a first coordinate of the target magnetic pole in a target quadrant of a quadrant coordinate system;
obtaining a second voltage value based on the second magnetic field strength to obtain a second coordinate of the target magnetic pole in the target quadrant; and
obtaining the coordinate position based on the first coordinate and the second coordinate.

19. The one or more non-transitory computer-readable media of claim 15, wherein the instructions, when executed by the one or more processors, cause the tripod head to determine the current position of the target magnetic pole by determining a relative angle of the target magnetic pole by:
calculating an angle difference between a coordinate position and a coordinate axis, wherein the first magnetic induction device is located or a coordinate axis, and wherein the second magnetic induction device is located based on an arctangent function; and
determining, based on the angle difference, the relative angle of the target magnetic pole.

20. The one or more non-transitory computer-readable media of claim 15, wherein the instructions, when executed by the one or more processors, cause the tripod head to determine the actual rotation angle of the tripod head by:
one of:
obtaining a first angle between the current position of the target magnetic pole and the first magnetic induction device and a second angle between the initial position of the target magnetic pole and the first magnetic induction device; or
obtaining a first angle between the current position of the target magnetic pole and the second magnetic induction device, and a second angle between the initial position of the target magnetic pole and the second magnetic induction device; and
determining, based on the first angle and the second angle, an actual rotation angle of the tripod head.
